(19) United States
(12) Patent Application Publication
(10) Pub. No.: US 2011/0109528 A1
(43) Pub. Date: May 12, 2011

(54) WEARABLE DISPLAY APPARATUS

(75) Inventors: Yong-kweun MUN, Yongin-si (KR); Hong-seok Lee, Yongin-si (KR)

(73) Assignee: SAMSUNG ELECTRONICS CO., LTD., Suwon-si (KR)

(21) Appl. No.: 12/942,405

(22) Filed: Nov. 9, 2010

(30) Foreign Application Priority Data
Nov. 9, 2009 (KR) 10-2010-0107520

(51) Int. Cl. G09G 5/00; G09G 3/36

(52) U.S. Cl. 345/8; 345/87

(57) ABSTRACT

A wearable display adopting a diffractive optical system includes a light source unit to emit light of a plurality of colors having wavelength bands which do not overlap each other; a light guide plate including a light guide portion to guide light incident from the light source unit by reflection, and a plurality of light output portions protruding from a surface of the light guide portion to output the light incident from the light source via a specular reflection as a surface light source. The light incident on a panel type optical modulation device from the light guide plate is modulated according to input image signals. The light emitted from the panel type optical modulation device is diffracted by a first diffractive device to be coupled to the waveguide and propagated by the waveguide. The light transferred through the waveguide is focused by an imaging device to form an enlarged image.

### CROSS-REFERENCE TO RELATED APPLICATIONS

This application claims the benefit under 35 U.S.C. §119(a) of Korean Patent Application No. 10-2010-0107520, filed on Nov. 9, 2009, in the Korean Intellectual Property Office, the disclosure of which is incorporated herein in its entirety by reference.

### BACKGROUND

1. Field

The following description relates to wearable display apparatuses, and more particularly, to wearable display apparatuses which may magnify image signals by using an enlarging light device such as glasses or goggles.

2. Description of the Related Art

Display apparatuses directly projecting images to eyes have been researched since 1965, in which Sutherland developed a display referred to as an ultimate display. These types of display apparatuses have been considered as ultimate displays in view of efficiency and effects of displaying images to humans.

However, until the 1990's, these types of display apparatuses were too heavy and big to be generally wearable, and thus, had been conventionally developed and used for military or specialized industrial uses and had not been distributed generally. After the 1990's, sizes of display systems have been greatly reduced due to developments such as flat panel displays, and thus, these types of display apparatuses have been applied for residential and commercial uses. These types of display apparatuses were aimed to display images of a large size during moving or in outdoor environments, however, since display systems were not sufficiently small and light to be used during such movement or in outdoor environments, and the displaying of images during such moving was of very limited application, these types of display apparatuses did not create a large sensation in the life of many people.

However, technologies in the flat panel display field have been greatly developed recently, and thus, performances of flat panel displays have been improved in view of small size, high definition (HD) level resolution, and fast response speed, separate from the development of wearable display apparatuses. In addition, various image information may be transferred in a mobile environment due to development of mobile devices, and a wireless solution for transmitting/receiving information and portable electric power technology including batteries have been also greatly improved. Therefore, demands for wearable display apparatuses in everyday life have been greatly increased, and technologies that may meet the demands of wearable display apparatuses have been developed.

One issue of concern regarding mobile devices is a size of the screen, because a large screen is necessary to deal with the increased amount and types of image information that is to be displayed. However, there is a limitation in increasing the size of screen due to a limited size of the mobile devices while maintaining portability. Thus, foldable displays or bendable displays have been suggested, however, there are many technical obstacles to realizing such foldable or bendable displays. In addition, even when the displays may be bendable or foldable, the largest screen size may be limited to about 7 inches in order to maintain the mobility of the mobile devices.

Wearable display apparatuses project virtual images to a sight of a user, and thus, a small system size may be compatible with a large screen. However, the wearable display apparatuses are to be small and light in order to be wearable by the user as a display of mobile devices. It may be considered that the wearable display apparatuses may be applied as mobile devices when the wearable display apparatus has a similar weight and size to those of glasses. Thus, wearable display apparatuses may aim to have a weight of less than about 30 g, however, there is a limitation in reducing weight and volume of refractive optics such as a lens and a prism. Therefore, diffractive optics such as a diffractive optical element (DOE) or a hologram optical element (HOE) may be used in the wearable display apparatuses, and combination of the diffractive optics and conventional panel type display devices such as a liquid crystal display (LCD), a liquid crystal on silicon (LCoS), or an organic light emitting display (OLED) have been developed.

However, when a general light source having a wide wavelength band is used as a light source, wavelength bands of light sources different from each other may overlap each other in a reactive region of a diffractive pattern due to a wavelength selectivity of the diffractive light device, and thus, color cross talk or a ghost image may be generated.

### SUMMARY

Provided are wearable display apparatuses using diffractive optics, and including a light source unit so that reactive regions of diffractive patterns do not overlap.

Additional aspects will be set forth in part in the description which follows and, in part, will be apparent from the description, or may be learned by practice of the presented embodiments.

The foregoing and/or other features and utilities may be achieved by providing a wearable display apparatus including a light source unit to emit light of a plurality of colors having wavelength bands which do not overlap each other, a light guide plate including a light guide portion to guide light incident from the light source unit by reflection, and a plurality of light output portions protruding from a surface of the light guide portion to output the light incident from the light source via a specular reflection as a surface light source, a panel type optical modulation device to modulate the light irradiated from the light guide plate according to input image signals to display images; a first diffractive device to diffract light incident from the panel type optical modulation device to change an optical path; a waveguide in which light incident from the first diffractive device propagates; and an imaging device to focus the light transferred through the waveguide to form an enlarged image.

The light guide plate may be disposed to maintain a polarization of light that is linearly polarized in a first direction, and the light output portion may include a light output surface that is parallel with the first direction.

The light output portion may be formed as an inverted trapezoid shape or a parallelogram.

The light source unit may include at least one laser device to emit a laser beam.

The light source unit may include red, green, and blue laser devices to respectively emit laser beams of red, green, and blue wavelength bands.

The light source unit may include red and blue laser devices to respectively emit laser beams of red and blue wavelength bands, and a green light emitting device (LED) to emit light of green wavelength band.

The light source unit may include red and blue LEDs to respectively emit red light and blue light, and a green laser device to emit a green laser beam.

The wearable display apparatus may further include a polarization device disposed between the light source unit and the light guide plate such that light of a linearly polarized component proceeds toward the light guide plate.

The panel type optical modulation device may be a transmissive liquid crystal display (LCD) device provided between the light guide plate and the first diffractive device.

The light guide plate may be configured to maintain a polarization direction of light that is linearly polarized in a first direction, the light output portion may have a light output surface that is parallel with the first direction, the light incident in the light guide plate from the light source unit may be linearly polarized in the first direction, and the transmissive LCD device may include two transparent substrates, a liquid crystal layer disposed between the two transparent substrates, and a polarization plate disposed on the transparent substrate adjacent to the first diffractive device.

The transmissive LCD device may be a mono-transmissive type, and the light source unit may be sequentially driven according to colors.

The transmissive LCD device may further include a color filter to display color images, and the light source unit and the transmissive LCD device may be sequentially driven according to the colors or may be driven simultaneously.

The panel type optical modulation device may be a reflective display panel, and the light guide plate may be provided between the panel type optical modulation device and the first diffractive device so that the light output portions face the panel type optical modulation device.

The panel type optical modulation device may be a panel displaying images by mirror driving, or an LCoS panel.

The panel type optical modulation device may be a mono-reflective type, and the light source unit may be sequentially driven according to colors.

The light source unit may include an infrared ray light device to emit infrared rays, wherein an eye tracking sensor array used to interface may be further disposed between the light guide plate and the first diffractive plate or on a side opposite to the panel type optical modulation device in the light guide plate.

The first diffractive device may include a plurality of holograms which respectively diffract the light of the colors to be coupled to the waveguide.

The imaging device may include a second diffractive device that includes a plurality of holograms which respectively diffract the light of each wavelength band transferred through the waveguide to eyes of a user and focus images of each color formed by the panel type optical modulation device on the eyes of the user.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic diagram illustrating a wearable display apparatus according to an exemplary embodiment;

FIG. 2 is an enlarged view illustrating a display image forming part in the wearable display apparatus of FIG. 1;

FIGS. 3A and 3B are cross-sectional views illustrating examples of a light guide plate according to an exemplary embodiment;

FIGS. 4A and 4B are cross-sectional views illustrating examples of a panel type optical modulation device included in the wearable display apparatus of FIG. 1;

FIGS. 5 and 6 are schematic diagrams illustrating a wearable display apparatus according to another exemplary embodiment;

FIG. 7 is an enlarged view illustrating a display image forming part in the wearable display apparatus of FIG. 6;

FIG. 8 is a schematic diagram illustarting a wearable display apparatus which may follow eyes of a user according to an exemplary embodiment;

FIG. 9 is an enlarged view illustrating a display image forming part in the wearable display apparatus of FIG. 8; and

FIG. 10 is a schematic diagram illustrating a wearable display apparatus which may follow eyes of a user according to another exemplary embodiment.

### DETAILED DESCRIPTION

Reference will now be made in detail to various exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain various aspects of these exemplary embodiments.

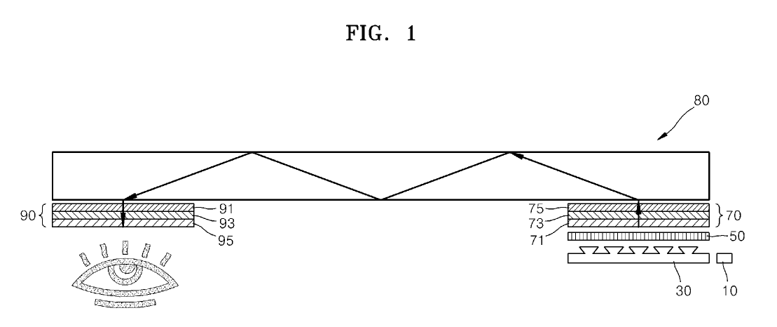

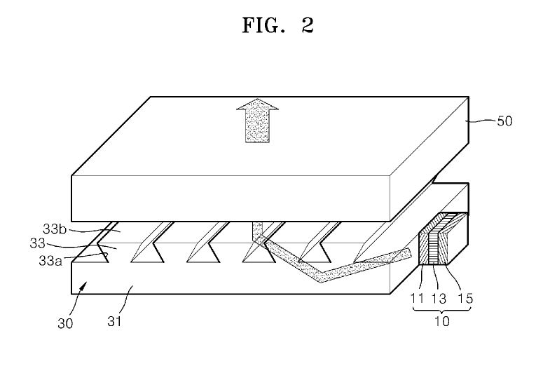

FIG. 1 is a schematic diagram illustrating a wearable display apparatus according to an exemplary embodiment, and FIG. 2 is an enlarged view illustrating a display image forming part in the wearable display apparatus of FIG. 1.

Referring to FIGS. 1 and 2, the wearable display apparatus of one exemplary embodiment may include a light source unit 10, a panel type optical modulation device 50 to modulate light according to input image signals to display images, a light guide plate 30 to guide light incident from the light source unit 10 to be irradiated onto the panel type optical modulation device 50 as a surface light source, a first diffractive device 70, a waveguide 80, and an imaging device 90.

The light source unit 10 may emit light of a plurality of wavelength bands which do not overlap each other. The light source unit 10 may include a plurality of light devices, for example, red, green, and blue light devices 11, 13, and 15 emitting light of red, green, and blue wavelength bands as illustrated in FIG. 2, and may include at least one laser device emitting a laser beam, that is, a semiconductor laser. The red, green, and blue light devices 11, 13, and 15 may be sequentially or simultaneously operated. In this exemplary embodiment, the wearable display apparatus displays color images by using red, green, and blue lights, however, other exemplary embodiments are not limited thereto, and the wearable display apparatus may be configured to display any number of color images, such as, for example, four or more.

In more detail, the light source unit 10 may include red, green, and blue laser devices emitting laser beams as the red, green, and blue light devices 11, 13, and 15. In another exemplary embodiment, the light source unit 10 may include red and blue laser devices emitting laser beams of red and blue wavelength bands, and a green light emitting device (LED) emitting light of the green wavelength band as the red, green, and blue light devices 11, 13, and 15. In yet another exemplary embodiment, the light source unit 10 may include red and blue LEDs emitting red light and blue light, and a green laser device emitting green light as the red, green, and blue light devices 11, 13, and 15. These examples are merely offered as various exemplary configurations of the light source unit 10, and it is understood that such a unit is not limited to these examples.

In other words, as described above, the light source unit 10 may include various types and configurations of the red, green, and blue light devices 11, 13, and 15 so as to emit the light of red, green, and blue wavelength bands. As previously discussed, the red, green, and blue light devices 11, 13, and 15 may be all laser devices, the green and blue light devices 13 and 15 may be laser devices and the red light device 11 may be an LED, or the red and blue light devices 11 and 15 may be LEDs and the green light device 13 may be a laser device.

In a case in which the red, green, and blue light devices 11, 13, and 15 are all laser devices, since wavelength bandwidths of the light emitted from the laser devices are narrow, the wavelength bands of the light emitted from the red, green, and blue light devices 11, 13, and 15 do not overlap each other.

In a case in which the red and blue light devices 11 and 15 are laser devices and the green light device 13 is an LED, the wavelength bandwidths of the light emited from the laser devices, that is, the red and blue light devices 11 and 15, are narrow while the wavelength bandwidth of the light emitted from the LED, that is, the green light device 13, is wide. Thus, the wavelength bands of the light emitted from the red, green, and blue light devices 11, 13, and 15 do not overlap each other.

When the red and blue light devices 11 and 15 are LEDs and the green light device 13 is a laser device, wavelength bandwidths of the light emitted from the red and blue light devices 11 and 15, which are located on both sides of a wavelength spectrum, are wide, however, the wavelength bandwidth of the light emitted from the green light device 13, which is located on a center of the wavelength spectrum, is narrow. Thus, the wavelength bands of the light emitted from the red, green, and blue light devices 11, 13, and 15 do not overlap each other.

As described above, the light source unit 10 may include at least one laser device so that the wavelength bands of the light do not overlap each other. That is, the light source unit 10 may be configured so that the light of the shortest wavelength and the light of the longest wavelength are emitted from the LEDs, and the light of intermediate wavelength is emitted from the laser device. The light source unit 10 may also be configured so that the light of the wavelength between two laser beams of different wavelengths emitted from the laser device may be emitted from the LED, and so on.

Therefore, when the light source unit 10 is configured so that the wavelength bands of the color beams do not overlap each other, wavelength bands do not overlap each other in reactive regions of diffractive patterns of diffractive devices such as, for example, the first diffractive device 70 and a second diffractive device, such as the imaging device 90, and thus, neither color cross talk nor a ghost image is generated. Thus, the wearable display apparatus including only the diffractive device without using a general lens may be realized.

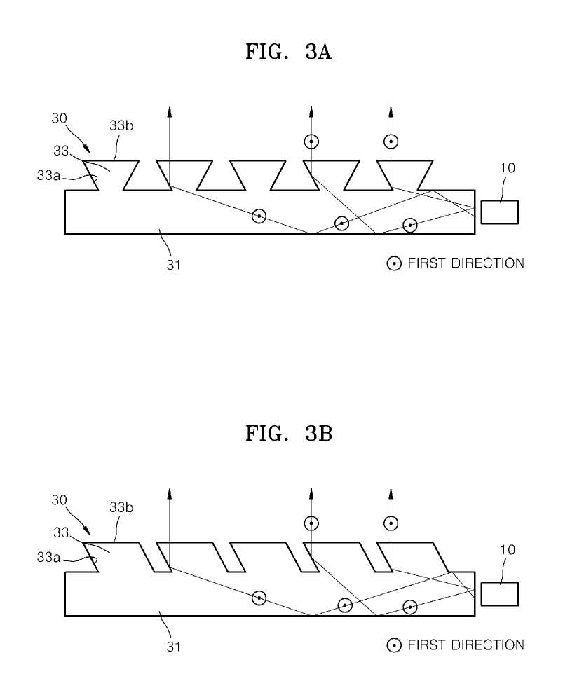

FIGS. 3A and 3B are cross-sectional views illustrating examples of the light guide plate 30.

Referring to FIGS. 3A and 3B, the light guide plate 30 may cause the light incident through a side surface thereof from the light source unit 10 to be irradiated onto the panel type optical modulation device 50 as a surface light source after being totally internally reflected from different respective surfaces in the light guide plate 30. The light guide plate 30 may include a light guide portion 31 to reflect the light emitted from the light source unit 10 to cause the light to proceed, and a plurality of light output portions 33 protruding from a surface of the light guide portion 31 so as to discharge the light emitted from the light guide portion 31 through specular reflection. The specular reflection is reflection of incident light at a constant angle. The light output portions 33 may be provided more densely further apart from the light source unit 10 so that the brightness of light emitted from the light guide plate 30 may be constant. That is, the number of light output portions 33 distanced further apart from the light source unit 10 may be greater than the number of light output portions 33 provided relatively nearer to the light source unit 10. As another example, the size of the light output portions 33 may become larger the further apart the light output portions 33 are provided from the light source unit 10. The light guide plate 30 may be formed of a transparent material. For example, the light guide plate 30 may be formed of polydimethylsiloxane that is transparent and flexible.

Each of the light output portions 33 of the light guide plate 30 may include an internal total reflecting surface 33a which is inclined with respect to the light guide portion 31 so as to cause the specular reflection and to maintain a polarization of the light that is linearly polarized in a first direction, and thus, outputs the light through a light output surface 33b. The first direction may be parallel with the internal total reflecting surface 33a and the output surface 33b, and the output portions 33 may be arranged as a line in the first direction.

Referring to FIG. 3A, the light output portion 33 may be formed as an inverted trapezoid shape, that is, a cross-sectional area of the light output surface 33b may be greater than a cross-sectional area of the light output portion 33 located adjacent to the light guide portion 31. As another example, as shown in FIG. 3B, the light output portion 33 may be formed as a parallelogram, that is, the cross-sectional area of the light output portion 33b may be equal to that of the light output portion 33 located adjacent to the light guide portion 31. In the subsequently discussed drawings illustrating embodiments of the wearable display apparatus, it is assumed that the light output portion 33 is formed as the inversed trapezoid shape as illustrated in FIG. 3A, as an example.

As described above, in a case in which the light guide plate 30 has the light output structure formed as the inverted trapezoid shape or the parallelogram shape, light that is totally reflected in the light guide plate 30 may be output, instead of light that is irregularly scattered. Therefore, the light incident in the light guide plate 30 may maintain the polarization, that is, the linear polarization in a direction parallel with the light output surface 33b. In addition, speckle patterns that are generated when the light is scattered by an irregular surface are not generated. Thus, the laser device may be used as a light source in the wearable display apparatus.

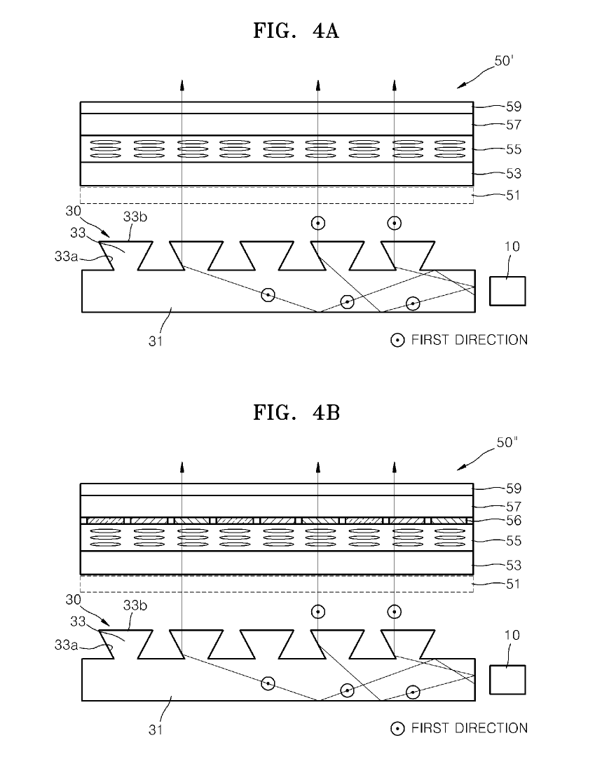

The panel type optical modulation device 50 may modulate the light irradiated from the light guide plate 30 according to input image signals to display images. Referring to FIGS. 4A and 4B, transmissive liquid crystal display (LCD) devices 50′ and 50″, which operate as transmissive shutters, may be examples of the panel type optical modulation device 50.

In examples in which the transmissive LCD devices 50′ and 50″ are used as the panel type optical modulation device 50, the panel type optical modulation device 50 may be located between the light guide plate 30 and the first diffractive device 70 as illustrated in FIG. 1. In this case, the light source unit 10 and the light guide plate 30 may function as a backlight unit (BLU).

FIGS. 4A and 4B illustrate examples of the transmissive LCD devices 50′ and 50″ which may be used as the panel type optical modulation device 50 in the wearable display apparatus of FIG. 1.

Referring to FIGS. 4A and 4B, the transmissive LCD device 50′ or 50″ may include two transparent substrates 53 and 57, a liquid crystal layer 55 disposed between the two transparent substrates 53 and 57, and a polarization plate 59 disposed on the transparent substrate 57 on an exit side. The transparent substrate 57 disposed on the exit side may face the first diffractive device 70.

If laser devices are used as the light devices 11, 13, and 15 emitting the light of different wavelength bands in the light source unit 10 and the light that is linearly polarized in the first direction is incident from the light source unit 10 to the light guide plate 30, the light guide plate 30 may collimate the light, and, at the same time, may adjust the light exit direction while maintaining the polarized direction of the light. Thus, the transmissive LCD device 50′ or 50″ may only require the polarization plate 59 on the exit side, and a polarization plate 51 at the incident side may not be necessary. In FIGS. 4A and 4B, the polarization plate 51 is denoted as dotted lines, as it is not considered necessary in this example.

FIG. 4A illustrates an example in which the transmissive LCD device 50′ is formed as a mono-structure that does not include a color filter.

For example, the red, green, and blue light devices 11, 13, and 15 included in the light source unit 10 of FIG. 2 may be sequentially operated, and color images may be displayed by the mono transmissive LCD device 50′.

FIG. 4B illustrates an example in which the transmissive LCD device 50″ includes a color filter 56.

In this case, the red, green, and blue light devices 11, 13, and 15 included in the light source unit 10 of FIG. 2 may be simultaneously driven, and thus, the color images may be displayed by the transmissive LCD device 50″. However, even in an example in which the transmissive LCD device 50″ includes the color filter 56, the red, green, and blue light devices 11, 13, and 15 in the light source unit 10 may be sequentially driven.

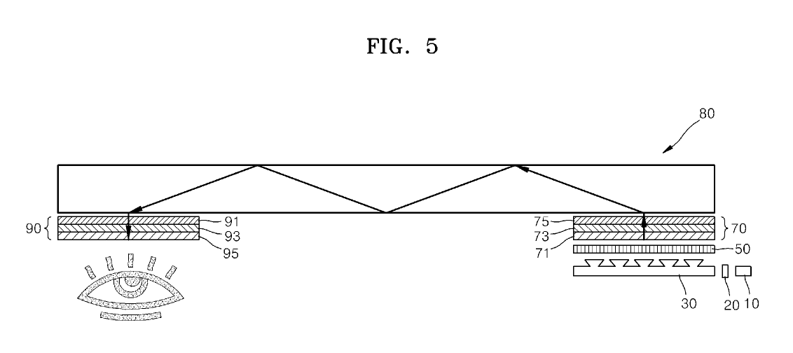

On the other hand, when at least one of the light devices 11, 13, and 15 is an LED, in an example in which polarization directions of the laser devices used as the remaining ones of the light devices 11, 13, and 15 are different from each other, or when the polarization directions of the laser beams emitted from the laser devices used as the light devices 11, 13, and 15 make an angle with the first direction, the polarization plate 51 may be further disposed under the transparent substrate 53 at an incident side as denoted by the dotted lines in FIGS. 4A and 4B, or a polarization device 20 may be further disposed between the light source unit 10 and the light guide plate 30 as illustrated in FIG. 5. The polarization device 20 may be integrally formed with the light source unit 10.

In this example, if an LED is used as at least one of the light devices 11, 13, and 15, a linear polarizer that transmits the light polarized in the first direction or a polarization conversion unit converting the light emitted from the light source unit 10 into the light polarized in the first direction may be used as the polarization device 20. In an example in which the polarization direction of the laser beams emitted from the laser devices that emit laser beams of the same polarization direction and are used as the light devices 11, 13, and 15 of the light source unit 10 makes a predetermined angle with the first direction, a wave plate that rotates a polarization plane may be installed so as to change the polarization direction of the laser beams into the first direction.

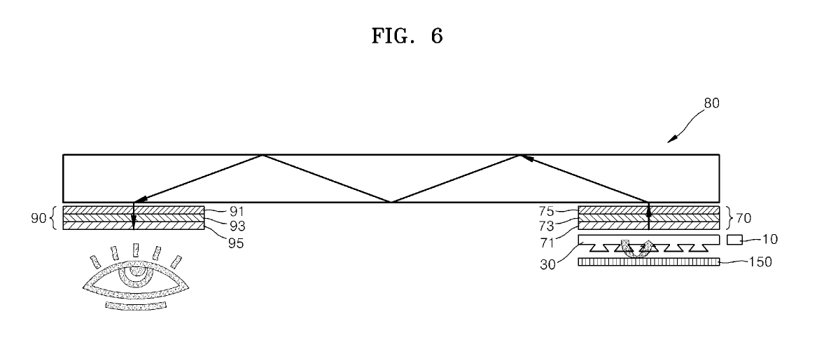

As previously described, in the wearable display apparatus illustrated in FIG. 1 or FIG. 5, the panel type optical modulation device 50 may be the transmissive type. However, as illustrated in FIG. 6, a reflective display panel may be used as a panel type optical modulation device 150 in one or more exemplary embodiments. Here, the panel type optical modulation device 150 may be a mono-reflective type display panel, and the light devices in the light source unit 10 may be sequentially driven. The panel type optical modulation device 150 may be configured to display color images, and the light source unit 10 and the panel type optical modulation device 150 may produce sequentially driven color light or a simultaneously driven plurality of color lights.

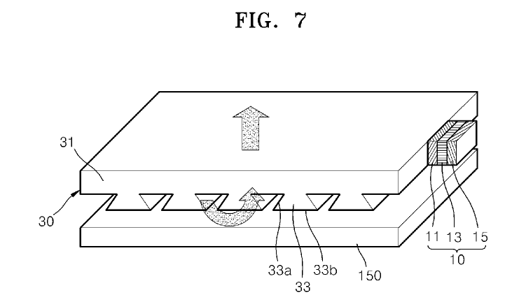

In the embodiment illustrated in FIG. 6, the light guide plate 30 may be disposed between the panel type optical modulation device 150 and the first diffractive device 70 such that the light output portion 33 faces the panel type optical modulation device 150. In FIGS. 6 and 7, the light guide plate 30 is in an inverted state relative to that of FIGS. 1 and 5 in which the transmissive display panel is used as the panel type optical modulation device 50.

The panel type optical modulation device 150 may be a panel displaying images by mirror driving (digital mirror device (DMD) or digital light processing (DLP)) or a reflective LCD device such as an LCoS panel.

In an example in which the reflective type panel is used as the panel type optical modulation device 150, the light may be irradiated from above the panel type optical modulation device 150 and the light modulated and reflected by the panel type optical modulation device 150 forms the image. Thus, in such an exemplary embodiment, the light source unit 10 and the light guide plate 30 function as a front light unit (FLU).

In this example, since the light guide plate 30 is formed of a transparent material, the light guide plate 30 may transmit the light reflected by the panel type optical modulation device 150 without blocking the light. In a case in which a panel displaying images by mirror driving is used as the panel type optical modulation device 150, an angle of the internal total reflection surface 33a of the light output portion 33 in the light guide plate 30 with respect to the light guide portion 31 may be changed so that the light may be incident onto the panel type light modulation device 150 from the light guide plate 30 while being slanted against the panel type light modulation device 150 and reflected to proceed in a direction perpendicular to the light guide plate 30. In a case in which a reflective LCD device such as the LCoS panel is used as the panel type optical modulation device 150, the light guide plate 30 may be designed to be the same as that when the transmissive panel is used as the panel type optical modulation device 150.

Further, in the wearable display apparatuses illustrated in FIGS. 1, 5, and 6, the light that is modulated to represent images by the panel type light modulation device 50 or 150 may be diffracted by the first diffractive device 70 to be coupled to the waveguide

The first diffractive device 70 may include a plurality of holograms 71, 73, and 75 which respectively diffract the light of each wavelength band to be coupled to the waveguide 80. FIGS. 1, 5, and 6 illustrate examples in which the first diffractive device 70 includes red, green, and blue holograms 71, 73, and 75 so that in an example in which the light source unit 10 includes the red, green, and blue light devices 11, 13, and 15, the red, green, and blue holograms 71, 73, and 75 respectively diffract the red, green, and blue lights to the waveguide 80.

The light coupled to the waveguide 80 propagates in the wave guide 80 via an internal total reflection operation, and is then transmitted to be incident on the imaging device 90.

The wearable display apparatus of the various embodiments may include a second diffractive device (hereinafter, the imaging device 90 is referred to as the second diffractive device 90) including a plurality of holograms 91, 93, and 95 to diffract the light of each wavelength band incident on the imaging device 90 from the waveguide 80 toward, for example, eyes of the user, and, at the same time, to focus the images of the colors formed by the panel type light modulation device 50 or 150 on the eyes of the user. As well known in the art, the hologram may be configured to change the optical path of the incident light by the diffraction and perform as a lens.

FIGS. 1, 5, and 6 illustrate examples in which the second diffractive device 90 includes red, green, and blue holograms 91, 93, and 95 so that in an example in which the light source unit 10 includes the red, green, and blue light devices 11, 13, and 15, the red, green, and blue holograms 91, 93, and 95 may diffract the red, green, and blue lights and focus red, green, and blue images.

According to the wearable display apparatus of the exemplary embodiments, at least one laser device in the light source unit 10 may be used so that the wavelength bands of the light do not overlap each other, and the light guide plate 30 having the collimation function, which may output the light by the specular reflection while maintaining the polarization characteristic of the laser beam and does not generate speckle patterns that are generated when the light is diffused by the irregular surface, that is, may adjust the light output direction, is used. Accordingly, the wavelength bands do not overlap each other in the reactive regions of the diffractive patterns of the first diffractive device 70 used to couple the light to the waveguide 80 or the second diffractive device 90 that is used as an imaging device, and thus, the color cross talk and/or the ghost image does not occur. In addition, since the laser beam that is a mono-color beam rarely has chromatic dispersion, may have the largest coupling efficiency in the diffractive patterns, and has good color purity, a color representation range of the display apparatus may be increased by using the laser beam. In addition, since the light guide plate 30 may distribute the light evenly onto the panel due to the specular reflection while maintaining the polarization characteristic of the laser beam, a collimation optical system formed as a lens is not necessary, and thus, a weight and volume of the wearable display apparatus may be greatly reduced. Also, the light guide plate 30 may be applied to both a transmissive panel or a reflective panel, and thus, the BLU or FLU may be realized.

Also, the wearable display apparatus according to one or more exemplary embodiments may include optics that may perform an eye tracking operation.

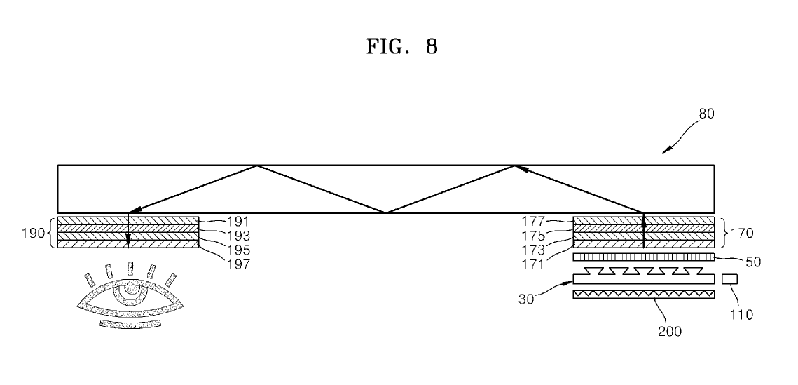

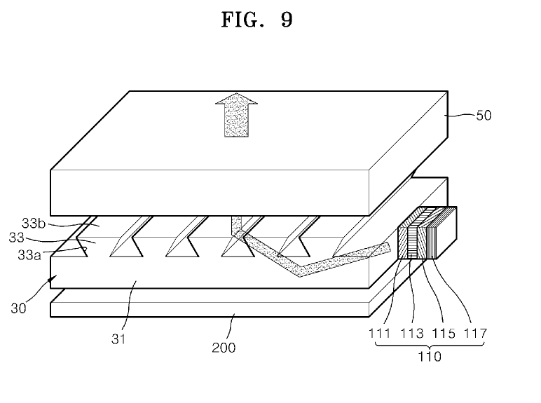

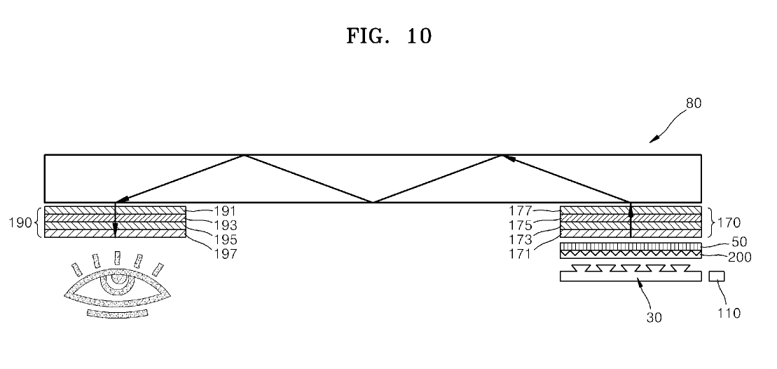

FIG. 8 is a schematic diagram illustrating a wearable display apparatus that may perform an eye tracking operation according to an exemplary embodiment, and FIG. 9 is an enlarged diagram illustrating a display image forming part in the wearable display apparatus of FIG. 8. FIG. 10 is a schematic diagram illustrating a wearable display apparatus that may perform an eye tracking operation according to another exemplary embodiment. Like elements as those of FIGS. 1 and 2 are denoted by the like reference numerals, and detailed descriptions of those will not be provided.

When comparing the wearable display apparatus of FIGS. 8 through 10 to that of FIGS. 1 and 2, the wearable display apparatus that may perform the eye tracking operation may include a light source unit 110 which further includes an infrared ray light device 117 that emits an infrared ray that is used to track the eyes in addition to red, green, and blue light devices 111, 113, and 115 such as those described in the discussion of the light source unit 10, and may further include an eye tracking sensor array 200 to interface between the light guide plate 30 and a first diffractive device 170 or on an opposite side of the panel type optical modulation device 50 of the light guide plate 30. In addition, in the embodiment illustrated in FIG. 8, the first diffractive device 170 corresponding to the first diffractive device 70 may further include a hologram 177 to couple the infrared used in tracking eyes to the wave guide 80 in addition to holograms 171, 173, and 175 used to couple the light used to display images to the waveguide 80. A second diffractive device 190 corresponding to the second diffractive device 90 may further include a hologram 197 to focus the infrared ray used to track eyes in addition to holograms 191, 193, and 195 used to focus the light used in displaying images.

Here, the red, green, and blue light devices 111, 113, and 115 correspond to the red, green, and blue light devices 11, 13, and 15. The holograms 171, 173, and 175 correspond to the holograms 71, 73, and 75, and the holograms 191, 193, and 195 correspond to the holograms 91, 93, and 95.

As illustrated in FIG. 10, the eye tracking sensor array 200 may be integrally formed with the panel type optical modulation device 50, and may be located between panel type optical modulation device 50 and the light guide plate 30. For example, the eye tracking sensor array 200 may be embedded in the substrate, on which a circuit used to drive the panel type optical modulation device 50, for example, a TFT to drive the liquid crystal layer of the transmissive LCD device, is disposed, that is, the transparent substrate 53 or 57 of FIGS. 4A and 4B. As another example, the eye tracking sensor array 200 may be formed separately from the panel type optical modulation device 50.

According to the wearable display device of the exemplary embodiments, at least one laser device may be provided in the light source unit so that the wavelength bands of the light do not overlap each other in reaction regions of diffractive patterns of the diffractive device that is used to couple the light to the waveguide or a coupling device. Thus, neither color cross talk nor a ghost image occurs. In addition, a light guide plate having a collimation function may be provided, which may output the light by the specular reflection while maintaining the polarization characteristic of the laser beam that does not generate speckle patterns that are generated when the light is diffused by the irregular surface, that is, the light guide plate may adjust the light output direction. Therefore, a coupling efficiency to the diffractive device is good, and a general lens type collimation optical system is not necessary, and thus, weight and volume of the display device may be greatly reduced.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A wearable display apparatus comprising:
a light source unit to emit light of a plurality of colors having wavelength bands which do not overlap each other;
a light guide plate comprising:
a light guide portion to guide light incident from the light source unit by reflection, and
a plurality of light output portions protruding from a surface of the light guide portion to output the light incident from the light source unit via a specular reflection as a surface light source;
a panel type optical modulation device to modulate the light irradiated from the light guide plate according to input image signals to display images;
a first diffractive device to diffract light incident from the panel type optical modulation device to change an optical path;
a waveguide in which light incident from the first diffractive device propagates; and
an imaging device to focus the light transferred through the waveguide to form an enlarged image.

2. The wearable display apparatus of claim 1, wherein the light guide plate is disposed to maintain a polarization of light that is linearly polarized in a first direction, and the light output portion includes a light output surface that is parallel with the first direction.

3. The wearable display apparatus of claim 2, wherein the light output portion is formed as an inverted trapezoid shape or a parallelogram.

4. The wearable display apparatus of claim 1, wherein the light source unit includes at least one laser device to emit a laser beam.

5. The wearable display apparatus of claim 4, wherein the light source unit comprises red, green, and blue laser devices to respectively emit laser beams of red, green, and blue wavelength bands.

6. The wearable display apparatus of claim 4, wherein the light source unit comprises red and blue laser devices to respectively emit laser beams of red and blue wavelength bands, and a green light emitting device (LED) to emit light of green wavelength band.

7. The wearable display apparatus of claim 6, further comprising a polarization device disposed between the light source unit and the light guide plate such that light of a linearly polarized component proceeds toward the light guide plate.

8. The wearable display apparatus of claim 4, wherein the light source unit comprises red and blue LEDs to respectively emit red light and blue light, and a green laser device to emit a green laser beam.

9. The wearable display apparatus of claim 8, further comprising a polarization device disposed between the light source unit and the light guide plate such that light of a linearly polarized component proceeds toward the light guide plate.

10. The wearable display apparatus of claim 1, wherein the panel type optical modulation device is a transmissive liquid crystal display (LCD) device provided between the light guide plate and the first diffractive device.

11. The wearable display apparatus of claim 10, wherein the light guide plate is configured to maintain a polarization direction of light that is linearly polarized in a first direction, the light output portion has a light output surface that is parallel with the first direction, the light incident in the light guide plate from the light source unit is linearly polarized in the first direction, and the transmissive LCD device comprises:
two transparent substrates;
a liquid crystal layer disposed between the two transparent substrates; and
a polarization plate disposed on the transparent substrate adjacent to the first diffractive device.

12. The wearable display apparatus of claim 11, wherein the transmissive LCD device is a mono-transmissive type, and the light source unit is sequentially driven according to colors.

13. The wearable display apparatus of claim 11, wherein the transmissive LCD device further comprises a color filter to display color images, and the light source unit and the transmissive LCD device are sequentially driven according to the colors or driven simultaneously.

14. The wearable display apparatus of claim 1, wherein the panel type optical modulation device is a reflective display panel, and the light guide plate is located between the panel type optical modulation device and the first diffractive device so that the light output portions face the panel type optical modulation device.

15. The wearable display apparatus of claim 14, wherein the panel type optical modulation device is a panel displaying images by mirror driving, or an LCoS panel.

16. The wearable display apparatus of claim 15, wherein the panel type optical modulation device is a mono-reflective type, and the light source unit is sequentially driven according to colors.

17. The wearable display apparatus of claim 15, wherein the panel type optical modulation device displays color images, and the light source unit and the panel type optical modulation device are sequentially driven according to the colors or driven simultaneously.

18. The wearable display apparatus of claim 1, wherein the light source unit comprises:
an infrared ray light device to emit infrared rays;
wherein an eye tracking sensor array used to interface is further disposed between the light guide plate and the first diffractive plate or on a side opposite to the panel type optical modulation device in the light guide plate.

19. The wearable display apparatus of claim 1, wherein the first diffractive device comprises a plurality of holograms which respectively diffract the light of the colors to be coupled to the waveguide.

20. The wearable display apparatus of claim 19, wherein the imaging device includes a second diffractive device that includes a plurality of holograms which respectively diffract the light of each wavelength band transferred through the waveguide to eyes of a user and focus images of each color formed by the panel type optical modulation device on the eyes of the user.
